(19) United States
(12) Patent Application Publication
(10) Pub. No.: US 2001/0022231 A1
(43) Pub. Date: Sep. 20, 2001

(54) Modular duct

(75) Inventor: Edward P. Dyer, Germantown, WI (US)

Correspondence Address: RYAN KROMHOLZ & MANION, S.C., Post Office Box 26618, Milwaukee, WI, 53226-0618, US

(73) Assignee: Hellermann Tyton Corporation

(21) Appl. No.: 09/765,050

(22) Filed: Jan. 18, 2001

Related U.S. Application Data
(60) Provisional application No. 60/178,104, filed on Jan. 26, 2000.

(51) Int. Cl. H02G 3/04

(52) U.S. Cl. 174/48

(57) ABSTRACT

An improved duct or raceway including a modular duct system and manufacturing technique for fabricating the components of the improved system as used in connection with electrical control panel wiring. The duct system utilizes an interlocking construction that may comprise extruded plastic base and top members connected to interlocking apertured sidewalls. The sidewall members, when fabricated by injection molding techniques provide for smooth surfaces for accepting protruding wires or relatively small wire bundles.

### BACKGROUND OF THE INVENTION

The present invention relates to wiring duct assemblies, and in particular to a modular duct assembly or raceway permitting expansion of components as needed to provide electrical wiring protection.

Past duct assemblies have presented numerous problems; especially where it is desired to expand a system once it has been installed. It often becomes necessary to provide additional raceway or duct components. Efforts to expand an already installed system involve the difficulties and expense of dismantling and reassembling various constituent components.

To overcome problems concerned with both the manufacture and installation of components used in a raceway wiring system, various wiring duct system embodiments have been provided. Such systems generally have utilized a main conduit section defining a main passage for wires, the wires generally being bundled together by means of longitudinally spaced wire ties, or encased in an insulating sheath. This main section was secured to a mounting surface.

In order to add additional passages for wires, one or more sidewall sections were added to the main section. The sidewall sections were apertured to provide various configured openings or slots to accommodate selected wires selected from a main raceway bundle. The wires emerging from the sidewall apertures were bent to follow exterior paths through other raceway systems, or to be directly connected an electrical device. The sidewalls have also been made without apertures, when no openings were necessary, nor desired.

Installers of wiring ducts often utilized a main section of relatively extended length enclosed by relatively short length sidewalls or covers. These sidewalls were preferably of various lengths and of desired aperture configurations. In these circumstances, it would be desirable to have the option of using interchangeable shorter sidewall lengths, which would be readily and facilely positioned along the main duct length during assembly and even substituted later without requiring major dismantling of the assembly.

Further, prior manufacturing techniques included die cut openings and edges creating relatively rough, and often undesirable sharp edges around the perimeter of the openings, making it difficult to install the needed wiring. The sharp edged perimeters also have been known to cut and remove wire insulation, particularly when the insulation has been applied as a thin coating to small diameter wires.

### SUMMARY OF THE INVENTION

The present invention overcomes the shortcomings of conventional duct products by providing interchangeable sidewalls of various configurations and lengths. The variety of interchangeable components allows for more compact packaging for shipping and inventory, resulting in lower shipping cost and less inventory space. The modular design also provides a much lower inventory cost due to fewer components required to make greater combinations of styles and sizes. Further, the invention contemplates an improved fabricating technique that avoids the sharp edges associated with prior production techniques.

It is a further object of this invention to provide a higher performing, higher quality product in an efficient manner. Devices made in accordance with this invention have particular application for networking, routing and protecting wire and cable in cable and wire management applications and installations.

The improved duct or raceway of this invention contemplates a modular duct system and manufacturing technique for fabricating the components of the improved system as used in connection with electrical control panel wiring. The duct system preferably embodies an interlocking construction that may comprise extruded plastic base and top members connected to interlocking apertured sidewalls. The sidewall members, when fabricated by injection molding techniques provide for smooth surfaces for accepting protruding wires or relatively small wire bundles. Sidewalls may be extruded and punched, however when this technique is used the resulting edges are mechanically chamfered to provide for smooth surfaces.

The base member is preferably provided with a pair of coextensive, laterally spaced, upstanding curbs. Each of the curbs includes a coextensive trough arranged to releasably receive a sidewall member. Additionally, the curb troughs each are preferably configured to receive a sidewall member by a snap-action grip. The grip is provided by means of a detent-indent arranged along the longitudinal lengths of the mating base and sidewall. Subsequent removal of a sidewall may be accomplished by sliding out through a base end or by prying upward in an indent well with a screw driver or other prying devices. The sidewalls may be apertured to provided any of several peripheral openings or slotted configurations arranged to receive segregated wires or relatively smaller wire bundles bent away from a main bundle lying in the longitudinal track defined by the laterally spaced curbs. Alternatively, the sidewall member may also be devoid of openings to provide a solid barrier and enclose the duct, or wireway. The top member is preferably provided with means to permit slideable engagement with the sidewalls. This engagement means may optionally include a bead of caulk or adhesive disposed in the engagement means to provide additional frictional engagement and assure proper fit between engaging members.

Initial assembly of the present invention is simplified over past duct systems. The bas member may be mounted to a control panel or other surface independently of the sidewalls. Sidewalls may then be added as needed as the total assembly is built. If additional width is required, the present invention provides further flexibility in application. In this case two base members may be assembled side by side. Use of three sidewalls provides for two outer sidewalls and an inner divider. In that case a central divider may be snap fit. Base members of varying widths are also within the scope of this disclosure.

### DESCRIPTION OF THE DRAWINGS

FIG. 1 is a perspective view of one embodiment of the invention, and illustrating a modular duct assembly including a cooperating top member, oppositely disposed, apertured sidewalls and a base member.

FIG. 2 is a cross sectional view taken along lines 2-2 of FIG. 1.

FIG. 2a is a fragmentary view of FIG. 2 and illustrates a means for facilitating removal of sidewall from the base by means of insertion of a wedge, such as a screwdriver tip at the juncture of the lower portion of the sidewall and a flexible curb outer wall extending upwardly from the base member.

FIGS. 3 and 4 are fragmentary cross sectional representations taken approximately along lines 2-2 of FIG. 1 and illustrating a modified base member with two versions of a separating partition or divider arrangement, suitable for selected installations of the assembly of this invention.

FIG. 5 is a fragmentary plan view of a molded apertured sidewall member, and particularly illustrating circular apertures with smooth edge surfaces for receiving wires or wire bundles.

FIG. 6 is a fragmentary plan view of a molded sidewall member including longitudinally spaced, upstanding fingers defining slots with smooth edges for receiving wires or bundles of wires.

FIG. 7 is a perspective view illustrating a modular duct assembly according to the present invention and used to retain a bundle of wires divided into two portions, one portion arranged to protrude through a slotted sidewall member and the other portion arranged to protrude through a sidewall member with circular apertures.

### DETAILED DESCRIPTION

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

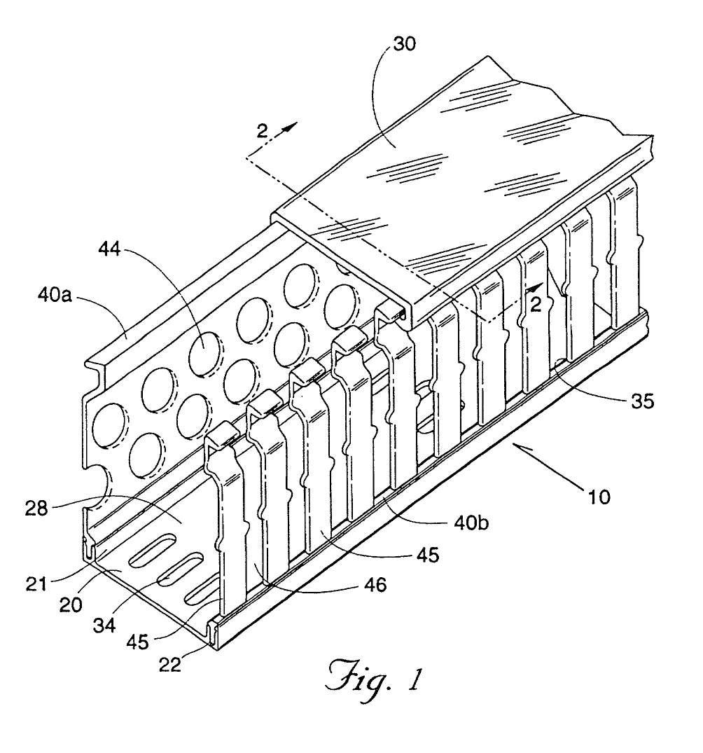

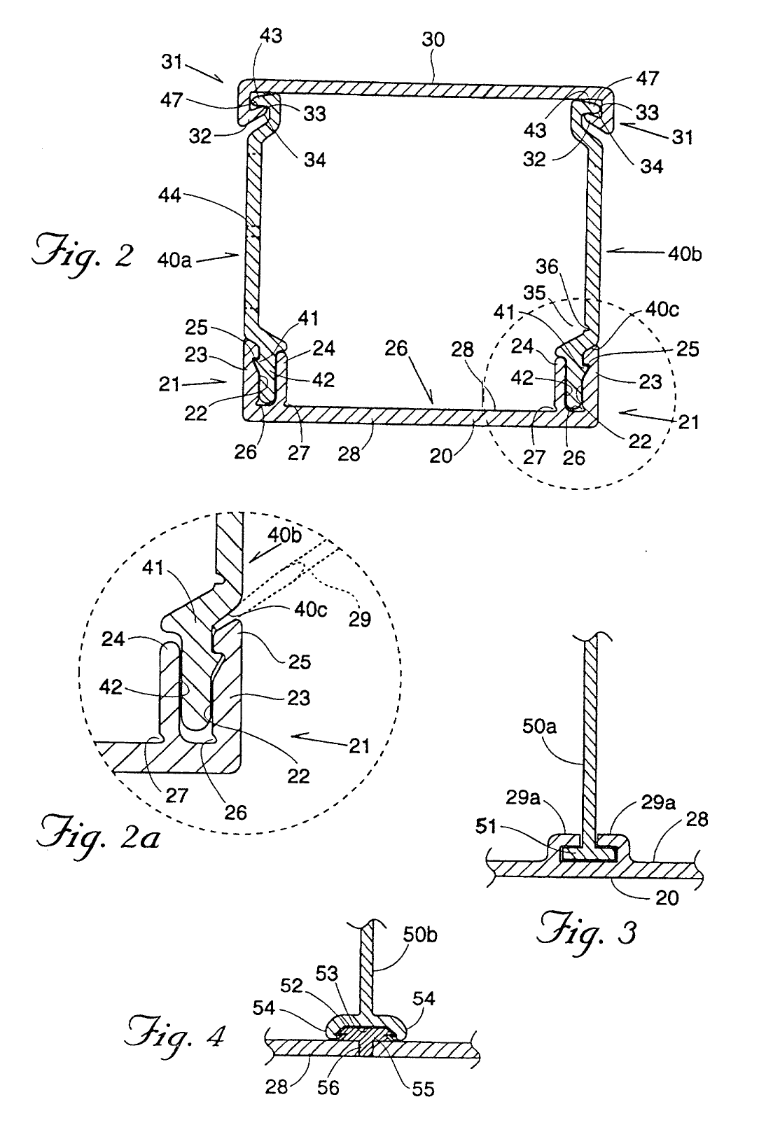

Referring to FIGS. 1 and 2, a preferred embodiment of the modular duct assembly 10 includes a base member 20, a top member 30, an apertured sidewall member 40a with circular openings 44 and a slotted sidewall member 40b. Slotted sidewall member 40b include adjacent fingers 45 that define a plurality of slotted apertures 4b. The members 20, insert space 30 and 40a and 40b are preferably made as independent components, with the members 40a and 40b being interchangeable. The sidewall members 40a and 40b are slidably secured to the base and top members 20 and 30, respectively. As shown in FIG. 2, sidewall member 40b preferably includes a frangible area 35 defined by longitudinal scoring or grooving 36. An enclosing, imperforate sidewall member (not shown) may also be substituted for the sidewall members 40a, 40b where access to protruding wires is not required. Further, as will be later explained, the sidewall members 40a, 40b are preferably configured to be independently removed and inserted from the bottom and top members 20 and 30, respectively, without disturbing previously assembled components. This arrangement is especially advantageous where the sidewall members 40a, 40b are shorter than the length of the base and top members 20 and 30. The shorter sidewall members 40a, 40b may be removed and replaced without disturbing adjacent sidewall sections or members by slip fitting or snapping into the base member 20. The top member 30 slides over the oppositely disposed sidewall members 40a and 40b.

Further, with respect to the fragmentary view of FIG. 2a, it will be observed that removal of the sidewall member 40b may be facilitated by wedging insertion of a conventional flat screwdriver tip 29 between the upper edge of the outer barb wall 23 and the abutting curved portion 40c to release the sidewall 40b from the groove 25.

The views of FIGS. 1 and 2 illustrate each of the component assembly members in their assembled relationship. The assembly shown includes the base member 20 with integrally formed, oppositely disposed, upstanding curbs 21. The curbs 21 preferably extend for the entire length of the base member 20 and each contain a generally U-shaped coextensive groove 22. Each of the curb grooves 22 are further defined by a pair of bifurcated outer and inner walls 23 and 24. The outer wall 23 also includes a coextensive, inwardly facing, indent or groove 25. The base member 20 may be extruded or injection molded of a relatively resilient material to provide a snap fit with a detent, or tongue 41 coextensive with a respective downwardly extending sidewall base portion 42. The base portion 42 of a respective sidewall member 40a, 40b may be releasably and slidably received by the groove 22 of a selected upstanding base member curb 21. The outer and inner walls 23 and 24 of the base member 20 are each provided with continuous bottom grooves 26 and 27, respectively. The grooves 26 and 27 provide flexibility to the walls 23 and 24 for ease in snap fitting the sidewall members 40a, 40b to the curbs 21 of the base member 20. The floor 28 of base member 20 may be further supplied with apertures 34 to allow mounting means (not shown) to pass therethrough.

Again referring to the view of FIG. 2, it will be observed that the top member 30, which may be formed as an extrusion, includes means for completing the assembly by a snap action fitting with respect to the top surfaces 43 of the sidewall members 40a and 40b. Preferably, the top member 30 is supplied with a pair of overhanging curbs 31. The curbs 31 each have a longitudinally extending overhanging flange 32 defining an undercut, coextensive groove 33. The grooves 33 each engage with a laterally extending elongated tongue 47 coextensive with the length of the top member 30. Since the sidewall members 40a, 40b are formed of plastic material, and extend upwardly away from the base member 20, the tongue 47 will be biased outwardly to slidably engage the groove 33. Selecting the width of the top member 30 to be slightly less than the width of the base member 20 may increase the relative tightness between the tongue 47 and the groove 33.

Referring next to the fragmentary views of FIGS. 3 and 4, the present invention may also provide divider means, when such is desired. As illustrated in FIG. 3, an upstanding separator or partition 50a may be slidably received between upstanding, inwardly curved, spaced apart, supporting members 29a and 29b. The members 29a and 29b are each preferably molded integrally with the floor 28 of the base member 20. The removable partition 50a is preferably extruded to a desired length, which is usually selected to be coextensive with the length of the base member 20, and may be of the same or lesser height than the sidewall members 40a, 40b. The partition 50a preferably includes a coextensive sub-base 51. The sub-base 51 is retained by a sliding fit in the groove formed between the facing support members 29a and 29b of this version of the base member 20.

Another version of the partitioning or dividing means is illustrated in the view of FIG. 4. Here, the divider, or partition, 50b includes a supporting base 52 providing a coextensive groove 53. The groove 53 is configured to provide inturned, shouldered flanges 54 that grasp the head 55 of a fastener 56.

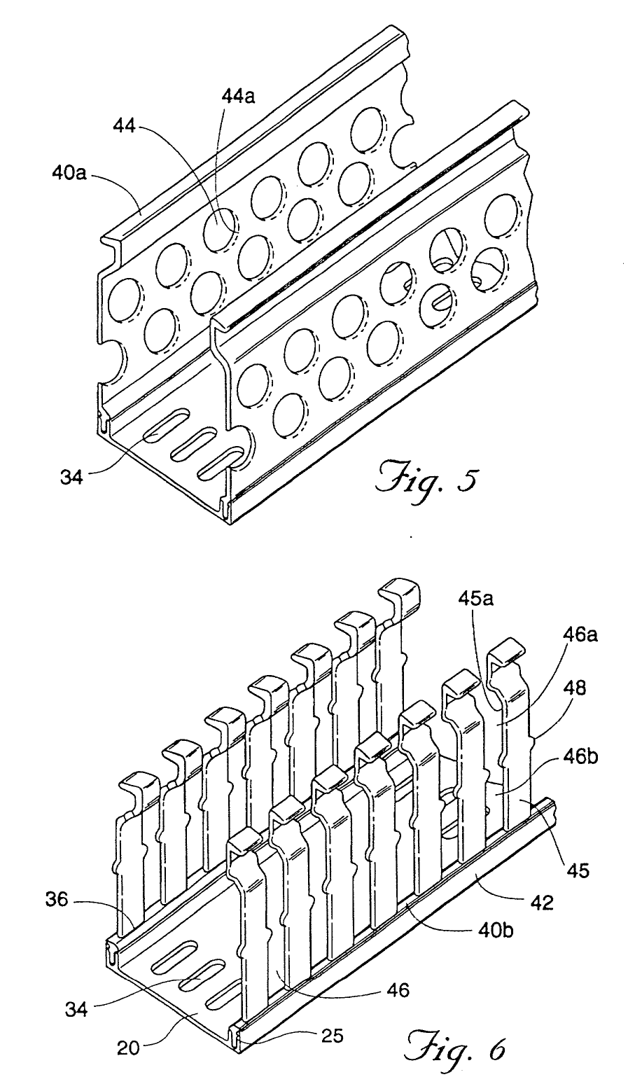

With reference to FIG. 1, it will be observed that the selected sidewall member 40a is provided with a plurality of spaced-apart, circular apertures 44. As mentioned above, sidewall 40a may be used on either side of the duct 10, when required. It will also be observed that each of the apertures 44 has a relatively smooth perimeter. The smooth perimeter, or edging, 44a (See FIG. 5) is achieved when the sidewall member 40a is formed by injection molding. Prior devices have generally been fabricated from extrusions that are die punched after extruding. Such machining operation provides relatively sharp perimeters, which can scrape off insulation from wires fed through the apertures 44 (See FIG. 7). This is especially true when relatively thin insulation is applied to small diameter wires used in communication installations. It will be apparent that where smooth surfaces are not required or desired the sidewall members 40a, 40b may be extruded and punched with mechanically formed chamfered edges without departing from other aspects of the invention.

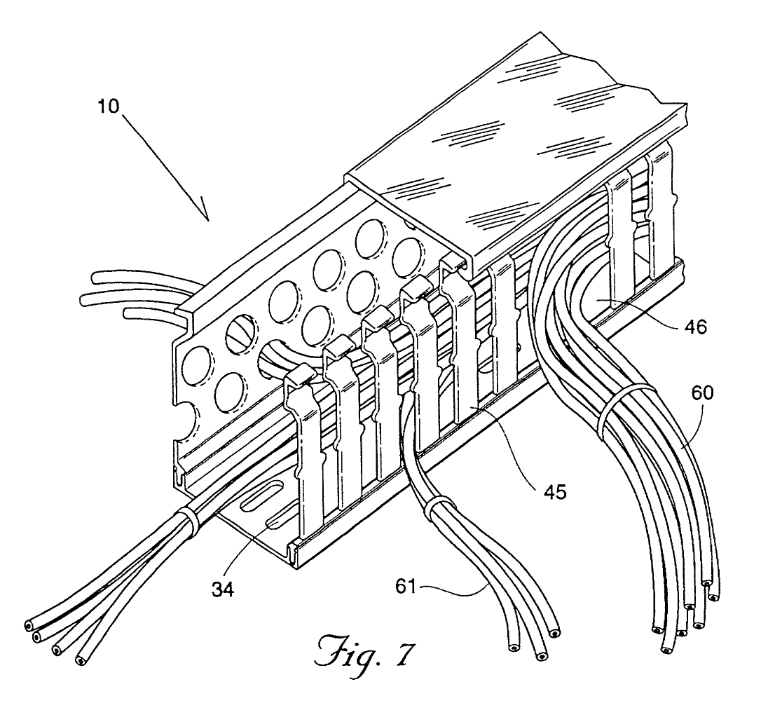

With respect to FIGS. 1 and 6, it will be observed that the sidewall member 40b is comprised of longitudinally spaced, upstanding fingers 45 projecting from the base portion 42 of the sidewall member 40b seated in the groove 25 of the base member 20. The adjacent fingers 45 define a plurality of slotted apertures 46. As in the case of the circular apertured sidewall member 40a, the sidewall member 40b is preferably injection molded to fabricate the fingers 45 with smooth edges 45a, as shown with particularity in the view of FIG. 6. At least one finger 45 preferably includes a frangible area 35 defining a longitudinal score or groove 36 at the base of individual fingers 45. This permits the individual finger or fingers 45 to be broken and removed to provide a wider slotted aperture 46 to accept a larger wire or bundled cable 60 passing therethrough. (See FIG. 7) Thus wires 61 passing through the slotted apertures 46 may do so without fear of scratching or removal of insulation. Laterally projecting ears 48 are provided intermediate the top and bottom portions of the fingers 45 to separate upper and lower portions 46a and 46b of the slotted apertures 46. The ears 48 provide a means of partitioning the slotted area for segregation of wires 61 or small wire or cable bundles 60, and thereby minimize entanglement of the wires during installation and removal of the wires or bundles from the slotted apertures 46.

With reference to FIG. 7, it will be observed that the modular duct assembly 10 finds use as a wiring device for transporting, supporting and distributing cable or wire bundles 60 or individual wires 61. As mentioned earlier, individual fingers 45 may be broken off to provide a wider slotted aperture 46 to accept bundled cable 60 therethrough.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. a modular conduit assembly comprising a base member, a removable top cover member and a pair of opposed sidewall members, at least one of said sidewall members having an integrally formed supporting portion releasably engageable with said base member, said base member including an upstanding, coextensive, longitudinal curb along a side thereof, said curb including a coextensive, longitudinal supporting groove, the surface of said supporting groove including means for providing snap-action engagement with said supporting portion of said one of said pair of sidewall members.

2. The modular conduit assembly claim 1, wherein said longitudinal supporting groove in said base member curb includes a side surface having an indent groove, and said supporting portion of said one of said pair of sidewall members including a coextensive longitudinal detent arranged to be releasably engageable with the indent groove in said base member curb.

3. The modular conduit assembly of claim 1, wherein said base member includes two upstanding, longitudinal curbs along opposed sides of said base member, and each of said curbs includes a longitudinal supporting groove arranged to receive the respective supporting portion of each of said sidewall members, and including means for snap-action engagement with said respective sidewall members.

4. The modular conduit assembly of claim 1, wherein said at least one of said sidewall member is included in a plurality of sidewall members supported in said base member supporting groove and has a longitudinal length less than the longitudinal length of said base member, and is independently removable from said base member with respect to an adjacent sidewall member.

5. The modular conduit assembly of claim 1, wherein said at least one of said pair of sidewall members comprises a plurality of longitudinally spaced fingers extending laterally from said supporting portion of said sidewall member, and wherein adjacent fingers define wire-receiving, open-ended, slotted areas.

6. The modular conduit assembly of claim 4, wherein said at least one of said pair of sidewall members comprises a plurality of longitudinally spaced fingers extending laterally from said supporting portion of said sidewall member, and wherein adjacent fingers define wire-receiving, open-ended, slotted areas.

7. The modular conduit assembly of claim 1, wherein said at least one of said pair of sidewall members comprises a plurality of longitudinally spaced fingers extending laterally from said supporting portion of said sidewall member, and wherein adjacent fingers define wire-receiving, open-ended, slotted areas, said fingers each including a transverse scored area intermediate its ends to define a frangible area whereby said finger may be manually broken away from its respective sidewall member to increase the longitudinal width of said adjoining slotted area.

8. The modular conduit assembly of claim 5, wherein said at least one of said pair of sidewall members comprises a plurality of longitudinally spaced fingers extending laterally from said supporting portion of said sidewall member, and wherein adjacent fingers define wire-receiving, open-ended, slotted areas, said fingers each including a transverse scored area intermediate its ends to define a frangible area whereby said finger may be manually broken away from its respective sidewall member to increase the longitudinal width of said adjoining slotted area.

9. The modular conduit assembly of claim 1, wherein said at least one of said pair of sidewall members includes a plurality of laterally spaced circular openings dimensioned to receive wires of pre-selected diameters passing therethrough.

10. The modular conduit assembly of claim 4, wherein said at least one of said pair of sidewall members includes a plurality of laterally spaced circular openings dimensioned to receive wires of pre-selected diameters passing therethrough.

11. The modular conduit assembly of claim 1, wherein said base member includes a plurality of longitudinally spaced apertures arranged to receive mounting fasteners for securing said assembly to a supporting surface.

12. The modular conduit assembly of claim 5, wherein the sidewall members are formed from an individual molding, and the exposed side and bottom edges defining each of said longitudinally spaced fingers are smooth and nonabrasive to individual or bundled wires passing therethrough.

13. The modular conduit assembly of claim 9, wherein the sidewall members are formed from an individual molding, and the exposed periphery of each of said laterally spaced circular openings are smooth and non-abrasive to individual or bundled wires passing therethrough.

14. The modular conduit assembly of claim 1, wherein said base member includes an upstanding partition located intermediate said pair of opposed sidewall members.

15. The modular conduit assembly of claim 13, wherein said upstanding partition extends longitudinally relative to said base member and is adapted to be slideably received between oppositely disposed, inwardly curved, laterally spaced, supporting members.

16. The modular conduit assembly of claim 13, wherein said upstanding partition includes a supporting base, said supporting base including oppositely disposed inturned shouldered flanges, adapted to engage the underside of the head of at least one headed fastener embedded in said conduit base member.
